(19) United States
(12) Patent Application Publication
(10) Pub. No.: US 2013/0339008 A1
(43) Pub. Date: Dec. 19, 2013

(54) DEVICE AND METHOD FOR MAINTAINING VOICE COMMUNICATION SECURITY IN TERMINAL

(71) Applicant: Samsung Electronics Co., Ltd., Gyeonggi-do (KR)

(72) Inventor: Adam DOLINSKI, Warsaw (PL)

(21) Appl. No.: 13/911,648

(22) Filed: Jun. 6, 2013

(30) Foreign Application Priority Data
Jun. 7, 2012 (KR) 10-2012-0060962

(51) Int. Cl. G10L 25/48

(52) U.S. Cl. CPC G10L 25/48
USPC 704/201

(57) ABSTRACT

A device and a method for maintaining voice communication security in a terminal are provided, which enable the terminal to maintain security for a conversation during voice communication. The device includes a microphone for receiving voice data through a microphone in a voice communication mode; and a controller for making a control to decode encoded characters included in voice data received through a microphone in a voice communication mode, and then transmitting the decoded characters to a counterpart terminal communicating with the device.

### PRIORITY

This application claims the priority under 35 U.S.C. §119(a) to an application filed in the Korean Industrial Property Office on Jun. 7, 2012 and assigned Serial No. 10-2012-0060962, the entire content of which is incorporated herein by reference.

### BACKGROUND OF THE INVENTION

1. Field of the Invention

The present invention relates generally to a device and a method for maintaining voice communication security in a terminal, and more particularly to a device and a method for maintaining voice communication security in a terminal, which enable the terminal to maintain security for a conversation during voice communication.

2. Description of the Related Art

Recently, along with development of communication technologies, mobile phones have become lifestyle necessities.

A new etiquette culture according to the use of the mobile phones has been established, since mobile phones enable people to make calls at various times and locations.

In particular, when a call must be made in a place where many people are gathered, the surrounding people create a lot of noise and may also overhear a conversation of a confidential voice communication.

Therefore, in order to address this problem, various functions, such as a function for allowing a user to speak in a whisper a confidential voice communication function, etc., have been provided in order to enable a counterpart to clearly hear a voice of a user who speaks in undertones. However, despite of these functions, since the surrounding people may still overhear a conversation in a quiet place, even though a speaker speaks in undertones, the security such conversations cannot be guaranteed.

### SUMMARY OF THE INVENTION

The present invention is provided to address the above-described problems and provide at least the advantages described below. An aspect of the present invention provides a device and a method for maintaining voice communication security in a terminal, which enable the terminal to maintain security for a conversation during voice communication.

Another aspect of the present invention provides a device and a method for maintaining voice communication security in a terminal, which enable the terminal to maintain security for a conversation had by a user during voice communication.

In accordance with an aspect of the present invention, there a device for maintaining voice communication security in a terminal is provided, the device includes a microphone for receiving voice data through a microphone in a voice communication mode; and a controller for making a control to decode encoded characters included in voice data received through a microphone in a voice communication mode, and then transmit the decoded characters to a counterpart terminal communicating with the device.

In accordance with another aspect of the present invention, a method of maintaining voice communication security in a terminal is provided. The method includes when voice data is received through a microphone in a voice communication mode, determining whether encoded characters are included in the voice data; and decoding, upon a determination that the encoded characters are included in the voice data, the encoded characters included in the voice data and then transmitting the decoded characters to a counterpart terminal communicating with the terminal.

In accordance with another aspect of the present invention, a computer-readable recording medium readable by a processor in which a program for executing a method of maintaining voice communication security in a terminal is provided. The method includes when voice data is received through a microphone in a voice communication mode, determining whether encoded characters are included in the voice data; and decoding, upon a determination that the encoded characters are included in the voice data, the encoded characters included in the voice data and then transmitting the decoded characters to a counterpart terminal communicating with the terminal.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a construction of a terminal according to an embodiment of the present invention;

FIG. 2 is a flowchart illustrating a process of maintaining voice communication security in a terminal according to a first embodiment of the present invention; and

FIG. 3 is a flowchart illustrating a process of maintaining voice communication security in a terminal according to a second embodiment of the present invention.

### DETAILED DESCRIPTION OF EMBODIMENTS OF THE PRESENT INVENTION

Hereinafter, embodiments of the present invention are described in detail with reference to the accompanying drawings. In the following description, the same or similar elements may be designated by the same reference numerals although they are shown in different drawings.

A terminal according to an embodiment of the present invention includes a portable terminal and a stationary terminal. As used herein, a portable terminal refers to a movable electronic device that is easily carried, such as a video phone, a mobile phone, a smart phone, an International Mobile Telecommunication 2000 (IMT-2000) terminal, a Wide-Band Code Division Multiple Access (WCDMA) terminal, a Universal Mobile Telecommunication Service (UMTS) terminal, a Personal Digital Assistant (PDA) terminal, a Portable Multimedia Player (PMP) terminal, a Digital Multimedia Broadcasting (DMB) terminal, an E-book, a portable computer (e.g., a notebook, a tablet, etc.), a digital camera, or such devices. Further, herein a stationary terminal includes devices such as a desktop, a personal computer, or other such devices.

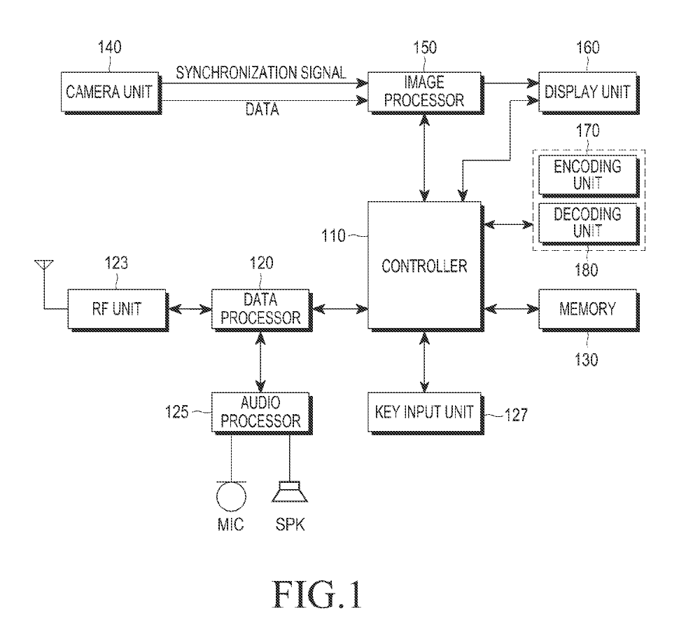

FIG. 1 is a block diagram illustrating a construction of a terminal according to an embodiment of the present invention.

Referring to FIG. 1, a Radio Frequency (RF) unit 123 performs a wireless communication function of the portable terminal. The RF unit 123 includes an RF transmitter for up-converting and amplifying a frequency of a transmitted signal, and an RF receiver for low noise amplifying a received signal and down-converting a frequency of the received signal. A data processor 120 includes a transmitter for encoding and modulating the transmitted signal, and a receiver for demodulating and decoding the received signal. That is, the data processor 120 may include a MODEM and a codec (not shown). The codec includes a data codec for processing packet data, and an audio codec for processing an audio signal such as a voice signal. An audio processor 125 reconstructs an incoming audio signal output from the audio codec of the data processor 120 and/or transmits an outgoing audio signal generated by a microphone (MIC).

A key input unit 127 includes keys for inputting information corresponding to numbers, characters, and function keys for setting various functions.

Further, the key input unit 127 may include specific keys used for converting a voice communication mode into a voice communication security maintaining mode for processing encoded characters included in voice data received from the microphone in the voice communication mode.

A memory 130 includes a program memory and a data memory. The program memory stores programs for controlling typical operations of a wireless terminal and programs for controlling decoding and transmission of encoded characters included in voice data received from the microphone in a voice communication mode according to an embodiment of the present invention. In addition, the data memory temporarily stores data generated during the execution of program.

Further, the memory 130 stores encoded characters corresponding to characters selected by a user in a character encoding mode according to an embodiment of the invention.

The memory 130 may alternatively store both original characters and encoded characters corresponding to the original characters selected by a user and the original characters in a character encoding mode according to an embodiment of the invention.

A controller 110 controls general operations of the wireless terminal. According to an embodiment of the present invention, the controller 110 controls the wireless terminal such that encoded characters included in voice data received through the microphone in a voice communication mode are decoded and then transmitted to a counterpart terminal communicating with the terminal.

Further, according to an embodiment of the present invention, the controller 110 converts a voice communication mode into a voice communication security maintaining mode when specific keys are input in the voice communication mode, and controls the wireless terminal such that encoded characters included in voice data received through the microphone in the voice communication security maintaining mode are decoded and then transmitted to the counterpart terminal.

Further, according to an embodiment of the present invention, the controller 110 controls such that characters selected by a user are encoded through corresponding encoding process in the character encoding mode and then stores the encoded characters. In addition, when the encoded character is included in voice data received through the microphone in the voice communication mode, the controller 110 controls the wireless terminal such that the encoded characters are decoded through the corresponding decoding process and then voice data including the decoded characters are transmitted to the counterpart terminal.

Further, according to an embodiment of the present invention, the controller 110 controls the wireless terminal such that original characters selected by a user are encoded through the corresponding encoding process in the character encoding mode and then controls storage of the original characters and the encoded characters. When the encoded character is included in voice data received through the MIC in the voice communication mode, the controller 110 controls the wireless terminal such that original characters corresponding to the encoded characters are extracted and voice data including the original characters are then transmitted to the counterpart terminal.

An encoding unit 170 encodes characters selected by a user in a character encoding mode. A decoding unit 180 decodes encoded characters included in voice data in a voice communication mode.

According to embodiments of the present invention, characters may be encoded and decoded by using various known encoding and decoding methods.

Herein, characters include both letters and numbers. For example, for letters/words, corresponding characters are encoded in a character encoding mode by using a substitution cipher method and characters encoded in the voice communication mode may be then decoded.

Further, for numbers, the numbers are encoded and decoded by using a particular function, such as a function defined by following Equation (1):

F(X)=((−1)ⁿ*X+a)mod 10 (1)

In Equation (1), “x” represents original numbers, “F(x)” represents encoded numbers. “a” is a preset random value, “n” is a value that increases each time encoding is performed.

A camera unit 140 includes a camera sensor for capturing image data and converting a captured optical signal to an electric signal and a signal processor for converting an analog image signal captured by the camera sensor to digital data. The camera sensor may be a Charge-Coupled Device (CCD) or a Complementary Metal-Oxide Semiconductor CMOS sensor, for example, and the signal processor may be a Digital Signal Processor (DSP). Furthermore, the camera sensor and the signal processor may be implemented either integrally or separately.

The image processor 150 performs Image Signal Processing (ISP) for displaying an image signal output from the camera unit 140 on a display unit 160. The ISP performs functions such as gamma calibration, interpolation, spatial change, image effect, image scale, Auto-White Balance (AWB), Auto-Exposure (AE), Auto-Focus (AF) or the like. Therefore, the image processor 150 processes an image signal output from the camera unit 140 in units of frames and outputs the frame image data according to characteristics and size of the display unit 160. In addition, the image processor 150 includes an image codec (not shown) and compresses frame image data displayed in the display unit 160 according to a preset scheme or a function of reconstructing compressed frame image data to original frame image data. The image codec may be a Joint Picture Experts' Group (JPEG) codec, a Motion Picture Experts' Group (MPEG)4 codec, a wavelet codec, etc. The image processor 150 is assumed to have an On Screen Display (OSD) function and can output OSD data depending on a size of a screen displayed under control of the controller 110.

The display unit 160 displays the image signal output from the image processor 150 on a screen and displays user data output from the controller 110. The display unit 160 may be implemented by a Liquid Crystal Display (LCD). In this event, the display unit 160 may include an LCD controller, a memory capable of storing image data, and an LED indicating element. When the display unit 160 is implemented as a touch screen, the LCD may operate as an input unit. In this event, keys such as the key input unit 127 may be displayed in the display unit 160.

Further, when the display unit 160 is implemented as a touch screen, the input unit of the display unit 160 may include specific keys used for converting a voice communication mode into a voice communication security maintaining mode for processing encoded characters included in voice data received from a MIC in the voice communication mode.

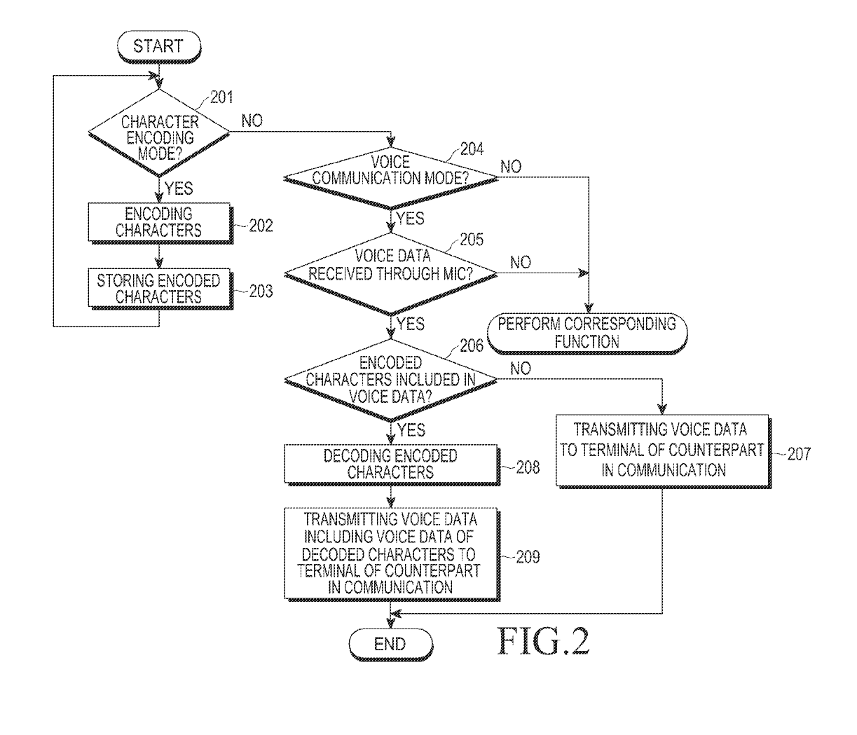

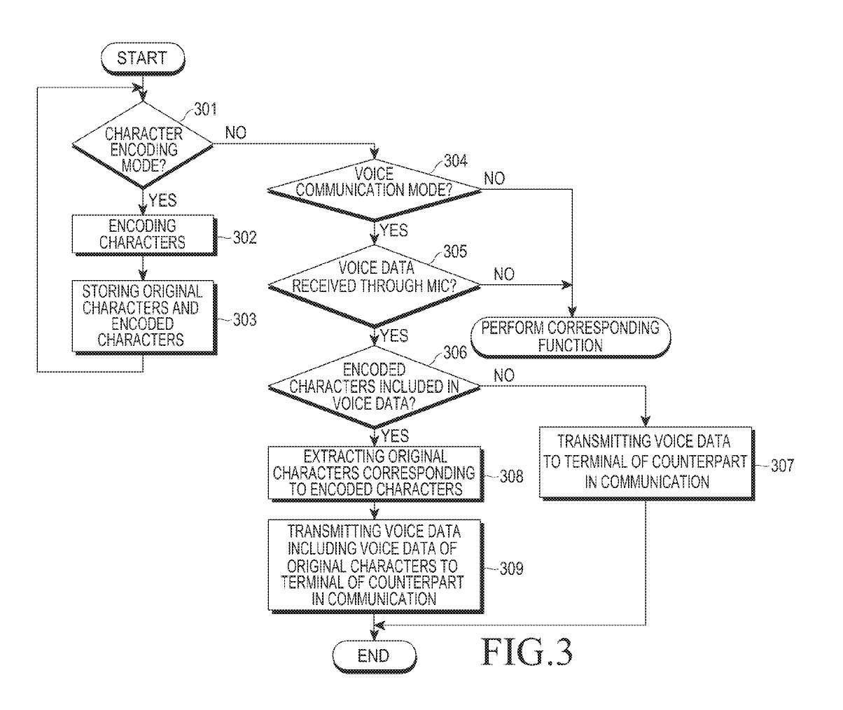

An operation capable of maintaining voice communication security in the terminal as described above is described in more detail as follows with reference to FIGS. 2 and 3.

FIG. 2 is a flowchart illustrating a process of maintaining voice communication security in a terminal according to an embodiment of the present invention.

Referring to the FIG. 2, when the controller 110 detects selection of a character encoding mode in the terminal, the controller 110 converts a mode of the terminal into the character encoding mode.

When corresponding characters are input or selected by a user in the character encoding mode, the controller 110 encodes the corresponding characters through the encoding unit 170, in step 202. When, voice data is input by a user through the microphone, in addition to the input or selection of the corresponding characters, the controller 110 converts the voice data into character data and then encodes the converted characters through the encoding unit 170.

The controller 110 stores the encoded characters as encoded characters of the voice communication mode in the memory 130, in step 203.

When the controller 100 detects selection of a voice communication mode for performing voice communication in step 204, the controller 110 then converts a mode of the terminal into the voice communication mode.

When the controller 110 detects reception of voice data through the microphone in the voice communication mode in step 205, and the controller 110 converts the voice data into character data through a function of converting a voice or characters. The controller 110 also determines whether encoded characters are included in the converted character data with reference to encoded characters of the voice communication mode stored in the memory 130.

When the controller 110 detects input of specific keys in the voice communication mode, the controller 110 then converts the voice communication mode into a voice communication security maintaining mode. In the voice communication security maintaining mode, the controller 110 determines whether voice data is received through the microphone, in step 205.

When voice data is received through the microphone and the controller detects that the encoded characters are not included in the converted character data in step 206, the controller 110 then transmits voice data received through the microphone to a counterpart terminal communicating with the terminal, in step 207.

However, when the controller 110 detects that the encoded characters are included in the converted character data in step 206, the controller 110 then decodes the encoded characters through the decoding unit 180 in step 208.

In addition, the controller 110 converts character data including the decoded characters into voice data through the function for converting the voice or character and then transmits the converted voice data to the counterpart terminal, in step 209.

For example, in the character encoding mode, the characters “I love you” input by a user may be encoded by the encoded characters “AA” through the encoding unit 170, in step 202. Then, the encoded characters “AA” are stored in the memory 130 in step 203, the voice data “AA” are received through the microphone in the voice communication mode in steps 204 and 205, the voice data converts the character data and the encoded characters “AA” are decoded as the characters “I love you” through the decoding unit 180 in step 208, and the decoded characters “I love you” are converted into voice data and then transmitted to a counterpart that is in communication with the terminal, in step 209.

FIG. 3 is a flowchart illustrating a process of maintaining voice communication security in a terminal according to another embodiment of the present invention.

Referring to the FIG. 3, when the controller 110 detects selection of a character encoding mode in the terminal in step 301, the controller 110 then converts a mode of the terminal into the character encoding mode.

When corresponding characters are input or selected by a user in the character encoding mode, the controller 110 encodes the corresponding characters through the encoding unit 170, in step 302. When voice data is input by the user in addition to the corresponding characters input or selected by the user through a microphone, the controller 110 converts the voice data into character data through a function for converting a voice or characters and then encodes the converted characters through the encoding unit 170.

The controller 110 stores original characters input or selected by the user and the encoded characters corresponding to the original characters as encoded characters of the voice communication mode in the memory 130, in step 303.

For example, in the character encoding mode, the characters “I love you” input by the user may be encoded by the encoded characters “AA” through the encoding unit 170, in step 302. Then, “AA” (the encoded characters) and “I love you” (the original characters), which are interrelated, are stored in the memory 130 in step 303. The voice data “AA” is received through the microphone in the voice communication mode in steps 304 and 305, the voice data converts the character data and “I love you” (the original character) corresponding to “AA” (the encoded character) is extracted in the memory without decoding in step 308, The decoded character “I love you” is converted into voice data, and then the voice data is transmitted to a counterpart that is in communication with the terminal, in step 309.

When the controller 110 detects selection of a voice communication mode for performing voice communication in the terminal in step 304, the controller then converts the mode of the terminal into the voice communication mode.

When the controller 110 detects reception of the voice data through the microphone in the voice communication mode in step 305, the controller 110 then converts the voice data into the character data through the function of converting a voice or characters. Further, the controller 110 determines whether encoded characters are included in the converted character data, by referring to encoded characters of the voice communication mode stored in the memory 130.

Otherwise, when the controller 110 detects that specific keys are input in the voice communication mode, the controller 110 then converts a voice communication mode into a voice communication security maintaining mode. In the voice communication security maintaining mode, the controller 110 performs step 305.

When the controller 110 detects that the encoded characters are not included in the converted character data in step 306, the controller 110 then transmits voice data received through the microphone to the counterpart terminal, in step 307.

However, when the controller 110 detects that the encoded characters are included in the converted character data in step 306, the controller 110 then extracts original characters corresponding to the encoded characters of the voice communication mode stored in the memory 130 in step 308.

The controller 110 includes the extracted original characters in the character data instead of the encoded characters and converts the character data including the original characters into voice data through the function for converting the voice or the characters and transmits the converted voice data to a terminal of a counterpart terminal, in step 309.

A device and a method for maintaining voice communication security in a terminal according to embodiments of the present invention may be implemented as a code in a computer-readable recording medium. Such a computer-readable recording medium includes all types of recording devices suitable for storing data capable of being read by computer system. Examples of such recording mediums include Read-Only Memory (ROM), Random Access Memory (RAM), an optical disk, a magnetic tape, a floppy disk, a hard disk, a semiconductor nonvolatile memory, and etc. Such code may also be transmitted by carrier waves (e.g., for transmission through the internet). Further, the code may be distributed to the computer system connected with network and stored.

While the invention has been shown and described with reference to certain embodiments thereof, it will be understood by those skilled in the art that various changes in form and details may be made therein without departing from the spirit and scope of the invention as defined by the appended claims.

What is claimed is:

1. A device for maintaining voice communication security in a terminal, the device comprising:
a microphone for receiving voice data through a microphone in a voice communication mode; and
a controller for making a control to decode encoded characters included in voice data received through a microphone in a voice communication mode, and then transmitting the decoded characters to a counterpart terminal communicating with the device.

2. The device as claimed in claim 1, wherein the controller converts a voice communication mode into a voice communication security maintaining mode in response to a specific user input in the voice communication mode, the decoder decodes encoded characters included in the voice data received through the microphone in the voice communication security maintaining mode, and the communication unit transmits the decoded characters to the counterpart terminal.

3. The device as claimed in claim 1, further comprising:
an encoder for encoding characters selected by a user through a corresponding encoding process to generate the encoded characters; and
a memory for storing the encoded characters in a character encoding mode,
wherein, when the encoded characters are included in voice data received through the microphone on the voice communication mode, the decoder decodes the encoded characters through a corresponding decoding process, and the communication unit transmits the voice data including the decoded characters to the counterpart terminal.

4. The device as claimed in claim 1, further comprising:
an encoder for encoding original characters selected by a user through the corresponding encoding process to generate the encoded characters; and
a memory for storing the original characters and the encoded characters in a character encoding mode,
wherein, the controller extracts the original characters corresponding to the encoded characters, and the communication unit transmits the voice data including the original characters to the counterpart terminal.

5. The device as claimed in claim 1, further comprising:
a memory for storing the encoded characters and original characters corresponding to the encoded characters;
an encoding unit for encoding the original characters to generate the encoded characters; and
a decoding unit for decoding the encoded characters included in voice data received in the voice communication mode.

6. A method of maintaining voice communication security in a terminal, the method comprising:
when voice data is received through a microphone in a voice communication mode, determining whether encoded characters are included in the voice data; and
decoding, upon a determination that the encoded characters are included in the voice data, the encoded characters included in the voice data and then transmitting the decoded characters to a counterpart terminal communicating with the terminal.

7. The method as claimed in claim 6, wherein determining whether encoded characters are included in the voice data comprises:
converting, when a specific user input in the voice communication mode is received, the voice communication mode into a voice communication security maintaining mode; and
determining whether encoded characters are included in voice data received from the microphone in the voice communication security maintaining mode.

8. The method as claimed in claim 6,
receiving characters selected by a user in a character encoding mode;
encoding the received characters through a corresponding encoding process to generate the encoded characters; and
storing the encoded characters.

9. The method as claimed in claim 6, further comprising:
receiving original characters selected by a user in a character encoding mode;
encoding the received original characters to generate the encoded characters; and
storing the original characters and the encoded characters.

10. The method as claimed in claim 6, wherein transmitting the decoded characters comprises:
decoding, when the encoded characters are included in the voice data, the encoded characters through a corresponding decoding process; and
transmitting the voice data including the decoded characters to the counterpart terminal.

11. The method as claimed in claim 6, wherein transmitting the decoded characters comprises:
extracting, when the encoded characters are included in the voice data, original characters corresponding to the encoded characters; and
transmitting voice data including the original characters to the counterpart terminal.

12. A computer-readable recording medium readable by a processor in which a program for executing a method of maintaining voice communication security in a terminal, the method comprising:
when voice data is received through a microphone in a voice communication mode, determining whether encoded characters are included in the voice data; and
decoding, upon a determination that the encoded characters are included in the voice data, the encoded characters included in the voice data and then transmitting the decoded characters to a counterpart terminal communicating with the terminal.

13. The computer-readable recording medium as claimed in claim 12, wherein determining whether encoded characters are included in the voice data comprises:
converting, when a specific user input in the voice communication mode is received, the voice communication mode into a voice communication security maintaining mode; and
determining whether encoded characters are included in voice data received from the microphone in the voice communication security maintaining mode.

14. The computer-readable recording medium as claimed in claim 12, wherein the method further comprises:
receiving characters selected by a user in a character encoding mode;
encoding the received characters through a corresponding encoding process to generate the encoded characters; and
storing the encoded characters.

15. The computer-readable recording medium as claimed in claim 12, wherein the method further comprises:
receiving original characters selected by a user in a character encoding mode;
encoding the received original characters to generate the encoded characters; and
storing the original characters and the encoded characters.

16. The computer-readable recording medium as claimed in claim 12, wherein transmitting the decoded characters comprises:
decoding, when the encoded characters are included in the voice data, the encoded characters through a corresponding decoding process; and
transmitting the voice data including the decoded characters to the counterpart terminal.

17. The computer-readable recording medium as claimed in claim 12, wherein transmitting the decoded characters comprises:
extracting, when the encoded characters are included in the voice data, original characters corresponding to the encoded characters; and
transmitting voice data including the original characters to the counterpart terminal.
